(19) United States
(12) Patent Application Publication
(10) Pub. No.: US 2014/0320293 A1
(43) Pub. Date: Oct. 30, 2014

(54) OPERATOR ALERT AND HEIGHT LIMITATION SYSTEM FOR LOAD CARRYING MACHINES

(71) Applicant: Caterpillar Inc., Peoria, IL (US)

(72) Inventors: Robert W. Hunter, JR., Wake Forest, NC (US); Michael A. Calamari, Raleigh, NC (US); Paul E. Pottschmidt, Raleigh, NC (US); Joseph E. Forcash, Cranberry Township, PA (US); Steven Juricak, Cary, NC (US); Judson P. Long, Garner, NC (US)

(21) Appl. No.: 14/325,497

(22) Filed: Jul. 8, 2014

(51) Int. Cl. G08B 21/18; G01L 19/12

(52) U.S. Cl. CPC G08B 21/187; G08B 21/182; G01L 19/12
USPC 340/626

(57) ABSTRACT

A method for alerting an operator during linkage overload in a machine is disclosed. The method includes calculation of operational height of a payload carrier. Fluid pressure in one of a lift cylinder assembly and a tilt cylinder assembly is sensed and weight of a payload based on the fluid pressure is calculated. Maximum payload height based on the pressure of at least one of the lift cylinder assembly and the tilt cylinder assembly, is determined Based on the maximum payload height, a threshold payload height is determined and compared with an operational height of the payload carrier. When the operational height of the payload carrier is equal to or greater than the threshold payload height, at least one of a warning generation event and limiting raising of the lift cylinder assembly occurs.

### TECHNICAL FIELD

The present disclosure generally relates to load carrying machines. More specifically, the present disclosure relates to operator alert and height limitation system for load carrying machines.

### BACKGROUND

Load carrying machines, such as wheel loaders, may be used for moving material. The machines may have payload carriers, such as buckets, forks, and/or blades. The payload carrier may be connected to a linkage, which may be controllably actuated by at least one hydraulic cylinder. Typically, the payload carrier is manipulated by an operator, to perform a sequence of distinct functions to load the payload carrier. In a work cycle, the operator may first position the linkage at a position level to a pile of material. The payload carrier may then be lowered downward until the payload carrier is near a ground surface, parallel to the pile of material. Next, the operator directs the payload carrier to engage the pile of material and raises the payload carrier through the pile, to fill the payload carrier. Once filled, the operator racks or tilts the payload carrier back to capture the material. The operator then dumps the captured payload to a specified dump location. The payload carrier may then be returned to the pile to begin the work cycle again.

The above mentioned machines are typically rated for a maximum payload and a maximum payload height. Lifting and carrying payloads above maximum payload and maximum payload height is unfavorable. Excess weight at an elevated position can render the machine unstable, particularly, when driving over uneven surfaces. Also, lifting a payload more than the maximum payload at a height beyond the maximum payload height, may result in blowing of the pressure relief valve of the hydraulic cylinder. This may result in the dropping of the machine linkage as well as the payload carrier from an elevated position. Even if the payload is not exceeded the machine components may wear more quickly.

Further, the operator may also use these machines to move non-standard objects. For example, a wheel loader with a payload carrier attachment having forks may be used to move or stack dismantled cars or portions thereof. In this situation, it is difficult to establish the weight of the object and any predetermined center of gravity for such a load and correspondingly ensure that the maximum allowable height for the load is not exceeded. Operators may be required to use their best judgment to determine the maximum overall height of the payload, while ensuring that an acceptable height for the payload is not exceeded. This may cause unpredictability in cycle time and perhaps lead to the requirement to employ highly experience operators.

### SUMMARY OF THE DISCLOSURE

The present disclosure is related to a method for alerting an operator of a machine during linkage overload. The machine includes a payload carrier to hold payload, a lift arm having a first end attached to the payload carrier, a tilt cylinder assembly configured to tilt the payload carrier, a lift cylinder assembly configured to raise or lower the lift arm, a tilt position sensor configured to monitor tilt of the payload carrier, a lift position sensor configured to monitor lift of the lift arm, and at least one pressure sensor configured to monitor fluid pressure in at least one of the lift cylinder assembly and the tilt cylinder assembly.

According to the present disclosure, the method includes calculation of an operational height of the payload carrier, based on position signals from the lift position sensor and the tilt position sensor. Fluid pressure in the one of the lift cylinder assembly and the tilt cylinder assembly at an operating position is sensed by the at least one pressure sensor, and thereafter, weight of the payload based on the fluid pressure, is calculated. A maximum payload height based on the pressure of at least one of lift cylinder assembly and the tilt cylinder assembly, is estimated, wherein the maximum payload height is based on the weight of the payload of the payload carrier. Based on the maximum payload height of the payload carrier, a threshold payload height is determined and is compared with the operational height of the payload carrier. When the operational height of the payload carrier is equal to or greater than the threshold payload height, at least one of a warning generation event and limiting of raising of the lift cylinder assembly occurs.

### BRIEF DESCRIPTION OF THE DRAWINGS

FIG. 1 illustrates a machine, in accordance with the concepts of the present disclosure;

FIG. 2 illustrates a block diagram of an exemplary operator alert and height limitation system of the machine of FIG. 1, in accordance with the concepts of the present disclosure; and

FIG. 3 illustrates a flowchart for an exemplary method of alerting an operator during linkage overload in the machine of FIG. 1, in accordance with the concepts of the present disclosure.

### DETAILED DESCRIPTION

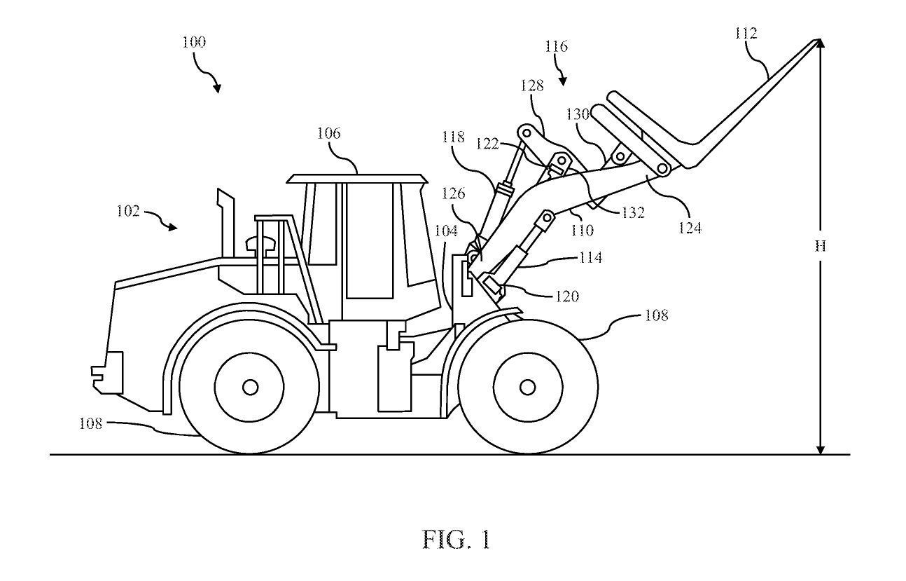

Referring to FIG. 1, there is shown a machine 100. The machine 100, as shown in FIG. 1, is a wheel loader, however other machines having an extendable arm to accommodate transporting a payload at the end of such arm are also envisioned. The machine 100 may include a body 102, an engine (not shown), a chassis 104, a cab 106, a pair of wheels 108, a pair of lift arms 110, a payload carrier 112, a lift cylinder assembly 114, a tilt linkage 116, a tilt cylinder assembly 118, a lift position sensor 120, and a tilt position sensor 122. The body 102 may house the engine (not shown), which propels the machine 100. The body 102 may be mounted on the chassis 104, which may support the cab 106 and may be made of steel or other metal. The chassis 104 may support various components of the machine 100, either directly or indirectly, such as body panels, hydraulic systems, and the like. The chassis 104 may be supported on the pair of wheels 108, which may be rotatably connected to the chassis 104. The pair of wheels 108 may rotate to propel the machine 100 in a desired direction.

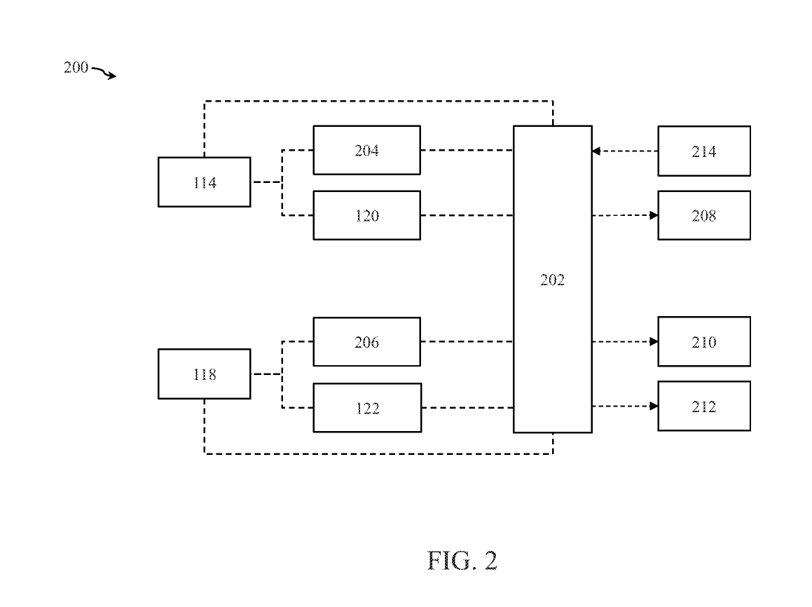

The body 102 may include the cab 106, attached to an upper middle section of the chassis 104. The cab 106 may be an enclosed structure with windows on lateral sides. The cab 106 allows the operator to sit and operate the machine 100. The cab 106 may allow an operator to access one or more controls. The cab 106 may include one or more operator interface devices. Examples of the operator interface devices include, but are not limited to, a joystick, a steering wheel, and/or a pedal (none of which are shown, but are well known in the industry). The operator interface devices may be located at any suitable location on the machine 100 and may also include a lift control device (shown in FIG. 2). The lift control device (shown in FIG. 2) may include one or more levers, joysticks, buttons, switches, pedals, and the like. The lift control device (shown in FIG. 2) may be operatively coupled to a lift mechanism to raise or lower the payload carrier 112.

The payload carrier 112 may be an attachment that supports a fork or forks, as exemplified in FIG. 1. Alternatively, the payload carrier 112 may be a platform, bucket, or any other means which may hold a payload such as an object or material. In other words, the machine 100 may operate in various modes, such as fork mode, bucket mode, and the like, based on the payload carrier 112 supported by the machine 100. The modes of operation may be selected by the operator interface device, such as an input panel, housed in the cab 106. The payload carrier 112 may be positioned at a front portion of the machine 100. The payload carrier 112 may be attached to the body 102 by a lift mechanism comprising the pair of lift arms 110, which extend between a back portion of the payload carrier 112, to another location on the chassis 104, immediately in front of the cab 106. The lift arm 110 may be pivotally attached to a rear portion of the payload carrier 112 at a first end 124, and pivotally attached to the chassis 104 at a second end 126. The lift arm 110 may be controlled to adjust operational height and position of the payload carrier 112, however the tilt linkage 116 (described below) may also be used to adjust operational height and position of the payload carrier 112, albeit to a lesser degree often referred to as “racking” the payload. The lift arm 110 may be lifted or actuated by the lift cylinder assembly 114, or other actuator. The lift cylinder assembly 114 may be pivotally attached to the chassis 104, beneath the lift arm 110.

The lift cylinder assembly 114 may be an actuator, such as a hydraulic cylinder. Expansion of the hydraulic cylinder may cause the lift arm 110 to pivot upwardly about its respective attachment to the chassis 104. Alternatively, retraction of the hydraulic cylinder may force the lift arm 110 to rotate downward about its attachment to the chassis 104. As the pair of lift arms 110 rotate about the respective attachments to the chassis 104, the payload carrier 112 may raise and lower accordingly.

The payload carrier 112 is additionally connected to the pair of lift arms 110 by the tilt linkage 116. The tilt linkage 116 changes the angular position of the payload carrier 112, relative to the pair of lift arms 110. The tilt linkage 116 may include a major tilt arm 128 and a minor tilt arm 130. The major tilt arm 128 may be an elongated metallic structure. A middle portion of the major tilt arm 128 may be connected to a first cross member 132, which extends horizontally between corresponding middle portions of the pair of lift arms 110. Similarly, the minor tilt arm 130 may be an elongated piece of metal, which extends and rotates. The minor tilt arm 130 may be connected to the rear portion of the payload carrier 112, at a position above the connections of the payload carrier 112 to the lift arm 110.

The angular position of the payload carrier 112, relative to the pair of lift arms 110, may be actuated by the tilt cylinder assembly 118, or other actuator. The tilt cylinder assembly 118 may rotatably connect an upper end of the major tilt arm 128 to a second cross member (not shown). The major tilt arm 128 may extend between the pair of lift arms 110, near the connections of the pair of lift arms 110 to the chassis 104. Similar to the lift cylinder assembly 114, the tilt cylinder assembly 118 may be an actuator, able to expand and retract, thereby rotating the major tilt arm 128 about its connection to the first cross member 132. The end of the major tilt arm 128, which is distal to the tilt cylinder assembly 118, is connected to the payload carrier 112 by the minor tilt arm 130. The tilt cylinder assembly 118 may expand through the tilt linkage 116, which may cause the payload carrier 112 to curl and rotate upward. Similarly, the tilt cylinder assembly 118 may retract in length, through the tilt linkage 116, which may cause the payload carrier 112 to tilt and rotate downwardly. In this manner, during a tilt operation of the payload carrier 112, the height of certain aspects of the payload carrier 112 changes (tip of the payload carrier 112, for example) and so does the position of the payload carrier 112 in the direction parallel with the ground.

As seen in FIG. 1, it will be understood that an overall operational height (H) of the payload carrier 112 may be calculated, based on the position sensor reading from the lift cylinder assembly 114 and the position sensor reading from the tilt cylinder assembly 118. A maximum payload height (Hₘₐₓ) for a particular payload weight may be calculated as defined below. Since each payload is likely to generate a unique maximum payload height (Hₘₐₓ), the operational height (H) may be arbitrarily identified as the end of the fork of the payload carrier 112. Alternatively, the present disclosure contemplates other indices may be used to identify the aspect of the machine 100 or its attachments to serve as the highest point of the machine 100, or the estimated center of gravity when the payload is in place on the payload carrier 112.

Physical data concerning the payload carrier 112 may be gathered through sensors on the linkage that connect the payload carrier 112 to the chassis 104, such as through the lift position sensor 120 associated with the lift cylinder assembly 114 and the tilt position sensor 122 associated with the tilt cylinder assembly 118. The lift position sensor 120 may be positioned on the lift cylinder assembly 114. The tilt position sensor 122 may be positioned on the first cross member 132. The lift position sensor 120 is configured to sense the position or lift of the lift arm 110. The tilt position sensor 122 is configured to sense the position or tilt of the payload carrier 112. The lift position sensor 120 and the tilt position sensor 122 may be rotational sensors, or other sensors known in the art. Generally, any mechanism or mechanisms known to those with ordinary skill in the art for measuring the lift and the tilt, respectively, in the lift cylinder assembly 114, and the tilt cylinder assembly 118, may be used.

Referring to FIG. 2, there is shown an operator alert and height limitation system 200 for use with machine 100 (FIG. 1). The operator alert and height limitation system 200 may include a controller 202, the tilt position sensor 122, the lift position sensor 120, a first pressure sensor 204, a second pressure sensor 206, a warning display 208, an audible alarm 210, and a warning light 212. The controller 202 may be configured to receive information from multiple sources, such as one or more of lift control device 214, the tilt position sensor 122, the lift position sensor 120, the first pressure sensor 204, and the second pressure sensor 206. The controller 202 may be configured to control one or more components of the machine 100, such as the warning display 208, the lift cylinder assembly 114, the tilt cylinder assembly 118, the audible alarm 210, and the warning light 212. The operator may input a command for an operation through the lift control device 214. The input is received by the controller 202. Accordingly, the controller 202 sends signals to the lift cylinder assembly 114, and the tilt cylinder assembly 118, to move the payload carrier 112.

The lift position sensor 120 senses the elevation of the lift arm 110. The tilt position sensor 122 senses the angular position, or tilt, of the payload carrier 112. Hence, the lift position sensor 120 and the tilt position sensor 122, respectively, produce position signals concerning the lift cylinder assembly 114 and the tilt cylinder assembly 118. The position signals are produced, in response to the position of the payload carrier 112. The position signals from the lift position sensor 120 and the tilt position sensor 122, are sent to the controller 202. Based on the tilt and lift, as measured by the tilt position sensor 122 and the lift position sensor 120, respectively, the controller 202 determines an operating position of the payload carrier 112. It may be envisioned that an operational height (H) may be calculated based on the respective positions sensed from the lift position sensor 120 and tilt position sensor 122, or alternatively the operational height (H), may be estimated from the reading of the lift position sensor 120 since a substantial portion of the overall operational height (H) is due to the movement of the lift arm 110.

The first pressure sensor 204 and the second pressure sensor 206, respectively, measure the fluid pressures in the hydraulic cylinders of the lift cylinder assembly 114 and the tilt cylinder assembly 118, at the operating position of the payload carrier 112. Hence, the first pressure sensor 204 and the second pressure sensor 206 produce pressure signals in response to the force exerted on the payload carrier 112, at the operating position. The pressure signals of the first pressure sensor 204 and the second pressure sensor 206, are sent to the controller 202. The pressure signal of the second pressure sensor 206 aids the controller 202 to determine moment about a pin which mounts the payload carrier 112 or a coupler to the lift arm 110. Also, based on the pressure signal of the second pressure sensor 206, the controller 202 determines the weight of the payload supported by the payload carrier 112. The controller 202 calculates the operational height (H) of the payload carrier 112, based on position signals from the lift position sensor 120 and the tilt position sensor 122.

The tilt cylinder assembly 118, through the second pressure sensor 206 will provide a pressure signal to the controller 202. The controller 202 will access memory to determine the maximum operational height (Hₘₐₓ). For example, a look-up table or map may be used to determine the maximum operational height (Hₘₐₓ). The look-up table may include the maximum operational height (Hₘₐₓ) corresponding to pre-determined values of lift cylinder position (as extracted from the position signal generated by the lift position sensor 120) and pressure in the tilt cylinder assembly 118 (as extracted from the pressure signal generated by the second pressure sensor 206). Based on the maximum operational height (Hₘₐₓ), the controller 202 determines the threshold payload height (H_{Th}). In an embodiment, the threshold payload height (H_{Th}) may be equal to or less than the maximum operational height (Hₘₐₓ). The controller 202 then compares the threshold payload height (H_{Th}) with the calculated operational height (H). If the operational height (H), for a particular weight of payload is allowed to exceed the threshold payload height (H_{Th}) and attain the maximum operational height (Hₘₐₓ), then the tilt cylinder assembly 118 may be exposed to overpressure or a depressurization event of a pressure relief valve in the tilt cylinder assembly 118. Therefore, when the fluid pressure in the tilt cylinder assembly 118 reaches a threshold pressure (a pressure just before overpressure), the payload and payload carrier 112 should not exceed the threshold payload height (H_{Th}), as has been estimated by controller 202.

As the payload carrier 112 exceeds the threshold payload height (H_{Th}), while carrying the payload, the controller 202 will generate an operator alert signal to warn of a potential overload or overpressure situation. Upon detection of pressure overload and generation of the operator alert signal, a linkage control limiting function may be employed by the controller 202 which may be dispatched by the operator alert and height limitation system 200. Specifically, when the controller 202 compares the operational height (H) with the threshold payload height (H_{Th}) and determines that the operational height (H) equals or exceeds the threshold payload height (H_{Th}), then the controller 202 sends a signal to the lift cylinder assembly 114, to limit or restrict the lift cylinder assembly 114 from further raising the payload carrier 112. This may be achieved by disabling of the lift control device 214.

In an embodiment, the operator alert signal generated by the operator alert and height limitation system 200 may be communicated to the warning display 208, which displays the warnings during the operations of the machine 100. The warning display 208 then displays a warning in response to the operator alert signal generated by the controller 202. The warning on the warning display 208 is accompanied by audible sound of the audible alarm 210 and flash of the warning light 212.

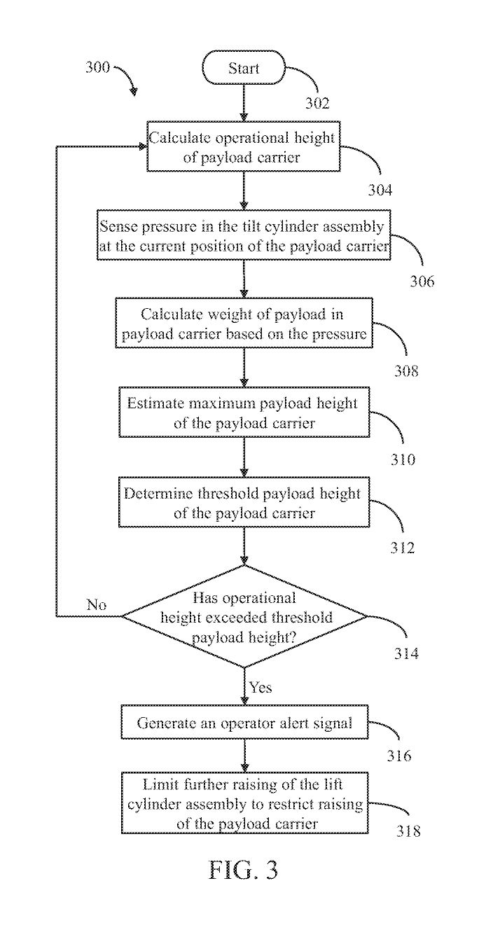

Referring to FIG. 3, there is shown a flowchart of a method 300 to alert the operator and limit the height of the payload carrier 112, if an overload condition of the payload (high pressure in the tilt cylinder assembly 118) is determined The method 300 begins with step 302 and proceeds to step 304.

At step 304, the controller 202 receives position signals from the lift position sensor 120 and the tilt position sensor 122. Based on the position signals, the operational height (H) of the payload carrier 112 is determined The method 300 proceeds to step 306.

At step 306, the controller 202 receives the pressure signal from the second pressure sensor 206 corresponding to the fluid pressure in the tilt cylinder assembly 118. The method 300 proceeds to step 308.

At step 308, the controller 202 calculates the weight of the payload in the payload carrier 112, based on the pressure signal received by the second pressure sensor 206. At this step, the controller 202 also calculates the moment about a pin which mounts the payload carrier 112, based on the pressure signal received by the second pressure sensor 206. The method 300 proceeds to step 310.

At step 310, the controller 202 estimates the maximum payload height (Hₘₐₓ). The maximum payload height (Hₘₐₓ) may be estimated on the basis of the pressure signal of the second pressure sensor 206. The maximum payload height (Hₘₐₓ) may be determined from the look-up table or map having values of one or more maximum payload heights (Hₘₐₓ) corresponding to pre-determined values of the pressure in the tilt cylinder assembly 118 and the position of the lift cylinder assembly 114. The estimated maximum payload height (Hₘₐₓ) corresponds to fluid pressure condition in the lift cylinder assembly 114 that is at or near an overpressure condition. The method 300 proceeds to step 312.

At step 312, the threshold payload height (H_{Th}) is determined, based on the maximum payload height (Hₘₐₓ). The threshold payload height (H_{Th}) may be equal to or lesser than the maximum payload height (Hₘₐₓ). For example, in the fork mode of operation, the controller 202 determines that the threshold payload height (H_{Th}) be 90% of the maximum payload height (Hₘₐₓ) or some other predetermined threshold payload height (H_{Th}) that best meets the operational needs. The method 300 proceeds to step 314.

At step 314, the controller 202 compares the operational height (H) of the payload carrier 112 with the threshold payload height (H_{Th}) of the payload carrier 112. If the operational height (H) is equal to or exceeds the threshold payload height (H_{Th}), then the method 300 proceeds to 316. If the operational height (H) is less than threshold payload height (H_{Th}), then the method 300 returns to step 304.

At step 316, the controller 202 generates the operator alert signal. Upon generation of the operator alert signal, the warning may be provided to the operator. The warning may be at least one of an audible alert on the audible alarm 210, a display alert on the warning display 208, and a flash alert of the warning light 212. The method 300 proceeds to final step 318.

At final step 318, the controller 202 sends a signal to the lift cylinder assembly 114, to limit any further raising of the hydraulic cylinder responsible for raising the lift arm 110. Limiting any further raising motion of the lift cylinder assembly 114 restricts the raising of the payload carrier 112 beyond the threshold payload height (H_{Th}). The raising of the lift cylinder assembly 114 may be limited by disabling the lift control device 214. It is envisioned that, on generation of the operator alert signal, the operator alert and height limitation system 200 may solely carry out the linkage control limiting function, or may carry out the linkage control limiting function along with actuation of the audible alarm 210 and the warning light 212.

### INDUSTRIAL APPLICABILITY

It may be seen that the method 300 for alerting the operator and limiting the payload height to protect against overload in the machine 100 may be employed. The method 300 provides an efficient way to detect the linkage overload condition for a particular payload weight by generation of a warning to the operator and limiting of further raising of the lift arm 110.

In operation, the operator manipulates user interface controls such as a joystick to lift, transport and release a load of material through the lift control device 214. For example, the operator actuates the machine 100 in fork mode of operation. The operator may use at least one of the operator interface devices to actuate the machine 100 in the fork mode. The controller 202 receives the input command and sends the signals to the lift cylinder assembly 114, to raise the payload carrier 112. While the payload carrier 112 is raised with the payload, the lift position sensor 120 and the tilt position sensor 122 send the position signals to the controller 202. The controller 202 then calculates the position of the payload (or payload carrier 112) based on the signals from the lift position sensor 120 and the tilt position sensor 122. In addition, the fluid pressure in the tilt cylinder assembly 118 is sensed by second pressure sensor 206 and communicated to the controller 202. The controller 202 receives the pressure signal related to the fluid pressure in the tilt cylinder assembly 118 and calculates the weight of the payload and the moment about a pin which mounts the payload carrier 112 or a coupler to the lift arm 110. The controller 202 then estimates the operational height (H), corresponding to the height of the payload at its current operational position. The controller 202 then refers to the look-up table and determines the maximum payload height (Hₘₐₓ) based on the pressure signal from the tilt cylinder assembly 118. Thereafter, for the fork mode of operation, the controller 202 may calculate the threshold payload height (H_{Th}) as 90% of the maximum payload height (Hₘₐₓ) or some other predetermined threshold payload height (H_{Th}) that best meets the operational needs. The controller 202 compares the operational payload height (H) with the threshold payload height (H_{Th}), to monitor whether the payload carrier 112 is approaching the predicted maximum payload height (Hₘₐₓ). When the controller 202 compares the operational height (H) with the threshold payload height (H_{Th}), and the operational height (H) of the payload carrier 112 is equal to or exceeds the threshold payload height (H_{Th}), then the controller 202 sends a signal to limit any further motion of the lift cylinder assembly 114 along with generation of warning alerts on the warning display 208, the audible alarm 210, and the warning light 212. However, the controller 202 may send a signal solely for limiting the motion of the lift cylinder assembly 114, unaccompanied with the warning alerts on the warning display 208, the audible alarm 210, and the warning light 212. Limiting the motion of the lift cylinder assembly 114 restricts further raising of the payload carrier 112. However, limiting the motion of the lift cylinder assembly 114 does not restrict lowering of the payload carrier 112. The disclosed method 300 for the operator alert and height limitation system 200 is effective for dumping operations of the machine 100, as it limits the motion of the lift cylinder assembly 114 to prevent equipment failure and failed transport of the payload. The disclosed method 300 provides a decreased operator cycle time by removing the process time for the operator to judge the payload and loading position of the payload. The machine 100 equipped with the operator alert and height limitation system 200, which helps to indicate payload overload. The disclosed method 300 also aids in improved customer confidence of operation due to improved load position indicators.

The present description is for illustrative purposes only and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claim.

What is claimed is:

1. A method for alerting an operator during linkage overload, for a machine with an operator alert and height limitation system, the machine including a payload carrier to hold payload, a lift arm having a first end attached to the payload carrier, a tilt cylinder assembly configured to tilt the payload carrier, a lift cylinder assembly configured to raise or lower the lift arm, a tilt position sensor configured to monitor tilt of the payload carrier, a lift position sensor configured to monitor lift of the lift arm, and at least one pressure sensor configured to monitor fluid pressure in at least one of the lift cylinder assembly or the tilt cylinder assembly, the method comprising:
calculating an operational height of the payload carrier, based on the position signals of the lift position sensor and the tilt position sensor;
sensing the fluid pressure in one of the lift cylinder assembly and the tilt cylinder assembly at operating position by the at least one pressure sensor, and calculating a weight of the payload based on the fluid pressure;
estimating a maximum payload height based on the pressure of at least one of lift cylinder assembly and the tilt cylinder assembly, wherein the maximum payload height is based on the weight of the payload of the payload carrier;
determining a threshold payload height based on the maximum payload height;
comparing the operational height of the payload carrier with the threshold payload height; and at least one of:
generating a warning if the operational height of the payload carrier is equal or greater than the threshold payload height; and
limiting raising of the lift cylinder assembly based on the operational height of the payload carrier being equal to or exceeding the threshold payload height.
